(19) United States
(12) Patent Application Publication
(10) Pub. No.: US 2025/0346343 A1
(43) Pub. Date: Nov. 13, 2025

(54) COMPOSITE SPAR

(71) Applicant: AIRBUS OPERATIONS, S.L.U., Madrid (ES)

(72) Inventors: Fernando INIESTA LOZANO, Madrid (ES); José Luis MARTÍNEZ MUÑOZ, Madrid (ES); Ignacio José MÁRQUEZ LÓPEZ, Madrid (ES); Alberto GALLEGOS ELVIRA, Madrid (ES)

(21) Appl. No.: 19/200,366

(22) Filed: May 6, 2025

(30) Foreign Application Priority Data
May 7, 2024 (ES) 202430354

(51) Int. Cl. B64C 3/18; B29C 70/44; B29K 307/04; B29L 31/30

(52) U.S. Cl. CPC B64C 3/185; B29C 70/443; B29K 2307/04; B29L 2031/3085

(57) ABSTRACT

A composite spar (100) for horizontal structures external to the fuselage of an aircraft, the composite spar (100) including a web (110) configured as a longitudinal element, upper and lower flanges (110a) and two distal ends, wherein for each end, the composite spar (100) includes an end portion (105) established in the longitudinal direction of the web (110), and a curved-edged end portion (120) with curved flanges (120a) and a truncated section (125) established in the transverse direction of the web (110), wherein the truncated section (125) is connectable to a frame of the fuselage of the aircraft and configured as a load transfer element between the web (110) and the frame, and wherein one or more of the lower flanges (110a) are connected to the curved flanges (120a).

### RELATED APPLICATION

This application incorporates by reference and claims priority to European patent application 202430354, filed May 7, 2024.

### TECHNICAL FIELD

The present invention relates to a composite spar for horizontal structures external to an aircraft fuselage and to manufacturing methods.

The present invention relates to advanced CFRP (carbon fiber reinforced polymer) structures, also known as composite structures, and their use in aircraft.

### BACKGROUND

FIG. 1A shows a first solution of the state of the art for joining the central box (1100) of the wing to the fuselage (1200) of an aircraft (1000) by means of normally metal accessories to transfer loads from the central box (1100) to the frame of the fuselage (1200).

FIG. 1B shows a sectional view of FIG. 1A wherein some metal accessories can be seen to transfer loads from the central box (1100) to the frame of the fuselage (1200), such as reinforcement bars (1300), fixing terminals (1400), as well as cutting webs (1500) and sealing points (1600).

A second solution for joining the central box to the aircraft fuselage involves integrating the center box into the fuselage frames. However, this solution requires cutting the left and right outer boxes, which are then attached to the central box using metal ribs and fittings.

Both state-of-the-art solutions require the use of metal accessories and fittings to join the central wing box to the aircraft fuselage.

There is a demand for a solution that allows the central box to be joined to the aircraft fuselage without requiring the use of metal fittings/accessories, thus reducing the assembly and maintenance effort, as well as reducing the weight of the structure.

WO2011086221A2 (corresponding to U.S. Pat. No. 8,740,138) describes a support pylon for aircraft engines joined to a section of the fuselage having a curved, closed cross-section including a skin and a plurality of frames. Its structural configuration comprises a central box inside the fuselage and two external side boxes on both sides thereof, all of which are made of composite material, the three boxes being structured as multi-spar boxes with upper and lower skins, side spars and at least one central spar. As joining means, rows of tension fittings are described between, respectively, the side spars of the external boxes and the side spars of the central box with tension bolts that cross the fuselage skin. The tension fittings are connected to said side spars by means of cutting rivets.

Thus, there is also a demand for solutions that allow support pylons for aircraft engines to be joined to the aircraft fuselage/airframe without requiring the use of metal fittings/accessories, rivets, etc., thereby reducing assembly and maintenance efforts and reducing the weight of the aircraft structure.

Generally, and given the state of the art, there is a demand for solutions for horizontal structures external to the aircraft fuselage, configured to be connected to the aircraft airframe more efficiently, while improving manufacturing and maintenance processes and reducing the weight of the aircraft structure.

### SUMMARY

The present invention relates to composite spars used for the manufacture of horizontal structures external to the aircraft fuselage, wherein said structures can be integrated into the aircraft's aerostructure in a more efficient manner, compared to the state of the art, without requiring the use of metal fittings/accessories or other connecting elements.

These structures can be, for example, a central box, a horizontal stabilizer, the support pylon for aircraft engines, etc. These structures are composed of composite spars that allow the connection of the structures to the fuselage of the aircraft and achieve a progressive load transfer through parts of the spar that comprise shapes adapted for load transmission, in contrast to the state of the art, wherein load transfer is carried out by means of normally metal elements or accessories.

The composite spar according to the present invention is a fuselage-integrable component that combines the structural functions of a longitudinal member and a frame member in a single piece, made entirely of carbon fiber-reinforced plastic or composite.

The composite spar can be used for any horizontal structure that requires connection to the aircraft's aerostructure. For example, the composite spar can be used in an aircraft's central wing box, for a horizontal stabilizer, for a horizontal pylon supporting one or more engines, etc.

In a first aspect, the invention relates to a composite spar for horizontal structures external to an aircraft fuselage, the composite spar comprising a web configured as a longitudinal element, upper and lower flanges, and two distal ends. At each distal end, the spar comprises a first end portion established in the longitudinal direction of the web, and a second end portion comprising curved edges with curved flanges and a truncated section established in the transverse direction of the web. The truncated section is connectable to a frame of the aircraft fuselage and is configured as a load transfer element between the web and the frame. In addition, one or more lower flanges are connected to the curved flanges.

In one example, the upper and lower flanges are rectilinear.

In another example, the end portion established in the longitudinal direction of the web comprises a second truncated section that allows the composite spar to be connected to other aircraft structures.

In a first preferred example, the spar further comprises a first reinforcement piece comprising a portion of the web and first reinforcement flanges comprising shapes equivalent to a portion of the lower flanges and a portion of the curved flanges.

In a second preferred embodiment, the composite spar further comprises a second reinforcing piece comprising a web portion and second reinforcing flanges comprising rectilinear shapes configured to connect the lower flanges along the surface of the curved-edged end portion.

In one embodiment of the second preferred example, the second reinforcement piece further comprises third reinforcement flanges comprising curved shapes configured to connect the curved flanges to the second reinforcement flanges.

In a third preferred example, the composite spar further comprises a third reinforcement piece comprising third reinforcement flanges comprising curved shapes configured to connect the curved flanges to the upper flanges and equivalent shapes to portions of the lower flanges and portions of the curved flanges.

A second aspect relates to a central box of an aircraft wing comprising a plurality of composite spars according to the preceding claims.

In a third aspect, the invention relates to a horizontal stabilizer comprising a plurality of composite spars according to the preceding claims.

In a fourth aspect, the invention relates to a horizontal support pylon for aircraft engines comprising a plurality of composite spars according to the preceding claims.

In a fifth aspect, the invention relates to a method for manufacturing the composite spar according to the first aspect of the invention. The method comprises pressing resin-pre-impregnated composite sheets to obtain a set of preforms, comprising a first preform comprising the web, distal end portions, comprising first end portions established in the longitudinal direction of the web, and one or more upper and lower flanges. The set of preforms further comprises second preforms comprising curved-edge end portions, one or more upper flanges and curved flanges, as well as third preforms comprising one or more reinforcing pieces configured to reinforce the structure of the spar or for load transmission. The method further comprises cutting the set of preforms, integrating the set of preforms into a vacuum assembly mold, vacuum assembling the pieces to obtain a spar preform, curing the spar preform, and removing the assembly mold and cutting burrs from the cured preform to obtain the composite spar.

In one example, obtaining third preforms comprises obtaining a first reinforcement piece comprising a portion of the web and first reinforcement flanges comprising shapes equivalent to a portion of the lower flanges and a portion of the curved flanges.

In one example, obtaining third preforms comprises obtaining a second reinforcement piece comprising a web portion and second reinforcement flanges comprising rectilinear shapes configured to connect the lower flanges along the surface of the curved-edged end portion.

In one example, obtaining the second reinforcement piece further comprises obtaining third reinforcement flanges comprising curved shapes configured to connect the curved flanges to the second reinforcement flanges.

In one example, obtaining third preforms comprises obtaining a third reinforcement piece comprising fourth reinforcement flanges comprising curved shapes configured to connect the curved flanges to the upper flanges and equivalent shapes to portions of the lower flanges and portions of the curved flanges.

In an eighth aspect, the invention relates to a method of manufacturing a horizontal support pylon for an aircraft engines, the method comprising assembling a plurality of composite spars according to the first aspect of the invention.

### SUMMARY OF DRAWINGS

In order to complement the description being made and in order to help a better understanding of the features of the composite spar in accordance with the present invention, some schematic figures are attached as an integral part of said description, wherein, for illustrative and non-limiting purposes, the following has been represented:

FIG. 1A shows one type of connection of the central box to the fuselage of an aircraft. FIG. 1B shows a sectional view of FIG. 1A.

FIG. 2 shows a composite spar according to the present invention.

FIG. 3 shows the preforms that, when assembled, form a first example of the composite spar according to the present invention.

FIGS. 4A, 4B, and 4C show the preforms that, when assembled, form a second example of a composite spar according to the present invention.

FIGS. 5A and 5B show the preforms that, when assembled, form a third example of a composite spar according to the present invention.

FIG. 6 shows a manufacturing method for composite spars according to the present invention.

### DETAILED DESCRIPTION

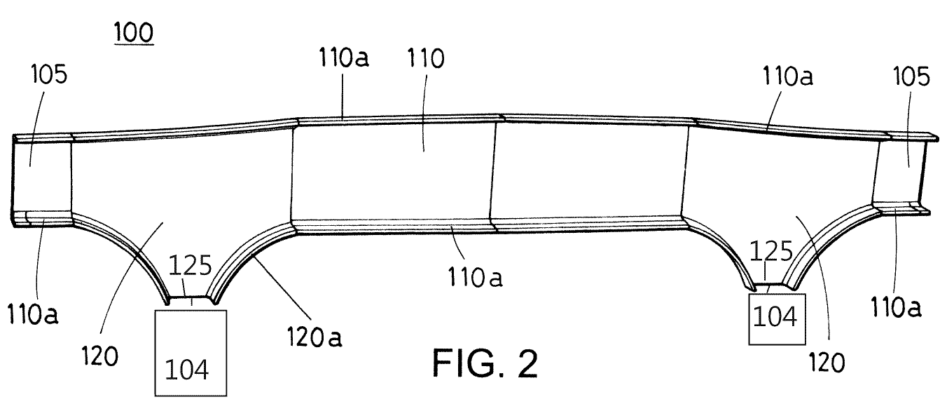

FIG. 2 shows an example of an assembly of preforms arranged to form a composite spar (100) according to the present invention. The composite spar (100) may be designed for a central box of an aircraft wing or for another type of horizontal structure external to the aerostructure, such as a horizontal stabilizer or a pylon.

The composite spar (100) is an assembly of preforms including a longitudinal spar element (102) that includes a web (110), and upper and lower flanges (110a). As can be seen in the figure, the longitudinal spar element (102) comprises two distal end portions (102) arranged along a longitudinal direction of the web (110). The web (110) of each distal end portion (102) receives a curved-edged end portion (120) that includes a truncated section (125) arranged in the transverse direction of the web (110). The web of the curved-edged end portion (120) is configured to be arranged in an abutting relationship, e.g., overlaps, with the web (11) of longitudinal spar element (102).

Furthermore, the curved-edge portions have curved flanges (120a) that are configured at one end to be adjacent ends of the lower flanges (110a) of the longitudinal spar element (102) and have an opposite end to be at a lower edge of the truncated section (125). As shown in FIG. 2, the lower flanges (110a) and the curved flanges (120a) form a generally continuous lower flange of the composite spar (100) except for a gap in the lower flange at the lower edge of the truncated section (125).

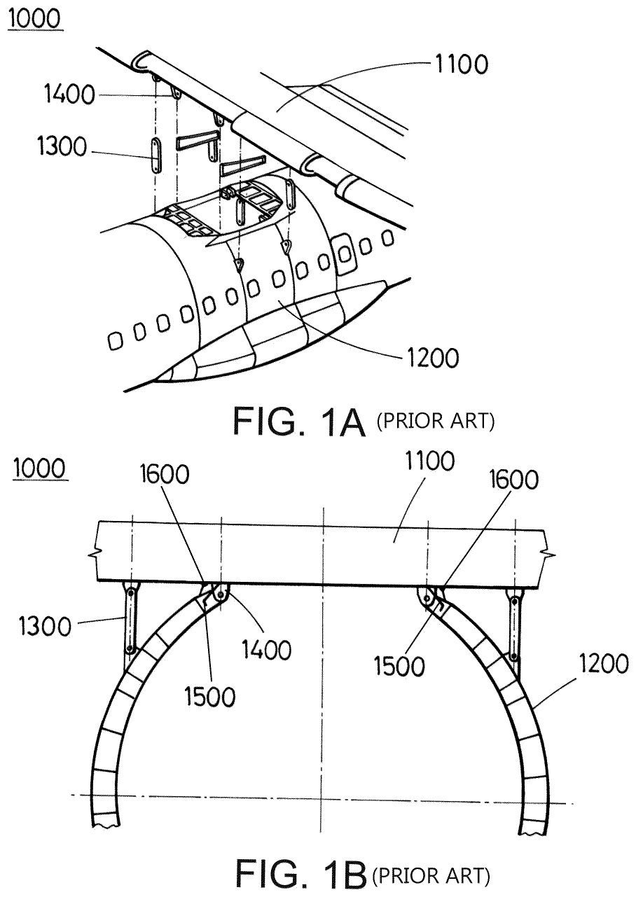

The truncated section (125) in each of the first curved-edged end portions (120) is connectable to a frame (104) of the aircraft fuselage, such as shown as 1200 in FIG. 1B. Loads are transferred between the frame and the spar (100) via the truncated sections (125). The fact that the section is truncated means that there is a plane that cuts the surface of the curved-edged end portion (120) as shown in FIG. 2. Other examples of truncated elements are, for example, a truncated pyramid.

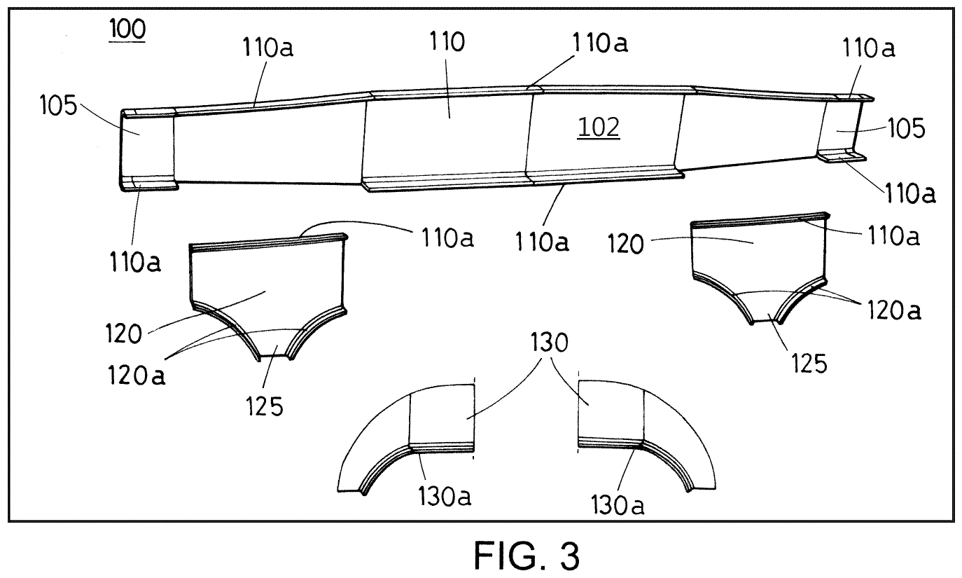

FIG. 3 shows a set of preforms to form a first example of a composite spar (100) according to the present invention. The preforms are intermediate pieces having a specific geometric configuration. The preforms are semi-rigid pieces, which become permanently rigid during the curing of the final piece. The final piece is obtained by vacuum-assembling the set of preforms.

Preforms are semi-rigid, pre-formed intermediate pieces with a geometric configuration. Their shape is definitively fixed during the final curing of all assembled preforms, resulting in the composite spar (100).

FIG. 3 shows in the upper part of the figure a preform comprising parts of the composite spar (100), such as: the web (110) with two distal ends comprising the end portions (105) established in the longitudinal direction of the web (110), as well as upper and lower flanges (110a) of the composite spar (100).

FIG. 3 shows in the middle part of the figure two preforms comprising the curved-edged end portions (120) each including curved flanges (120a) and upper flanges (110a). The upper flanges (110a) on the curve-edge end portions (120) are configured to overlap and reinforce portions of upper flanges (110a) of the longitudinal spar element (102). The web (110) of the longitudinal spare element (102) receives, e.g., abuts and is overlapped by, the webs of the curved-edged end portions (120). As can be seen in FIG. 3, the curved-edged end portions (120) comprise the truncated section (125) that allows the connection of the composite spar (100) to the frame of the aircraft fuselage and allows the load transfer between the web (110) and the frame.

FIG. 3 shows in the lower part of the figure two comprising two first reinforcing pieces (130) that can be assembled together with the other preforms shown in the figure. The web of the reinforcing pieces (130) overlap with, e.g., abut, portions of the webs of the curved-edged end portions (120) and the web (110) of the longitudinal spar element (102). The first reinforcing flanges (130a) of the first reinforcing pieces each abut, e.g., overlap, with a portion of the lower flange (110a) of the longitudinal spar element (102) and a curved flange (120a) of the curved-edged end portion (120). The first reinforcing pieces (130) reinforce the composite spar and particularly the transitions between the curved-edge end portions and the longitudinal spar element to reinforce the flanges of the composite spar (100), for example, lower flanges (110a) and curved flanges (120a).

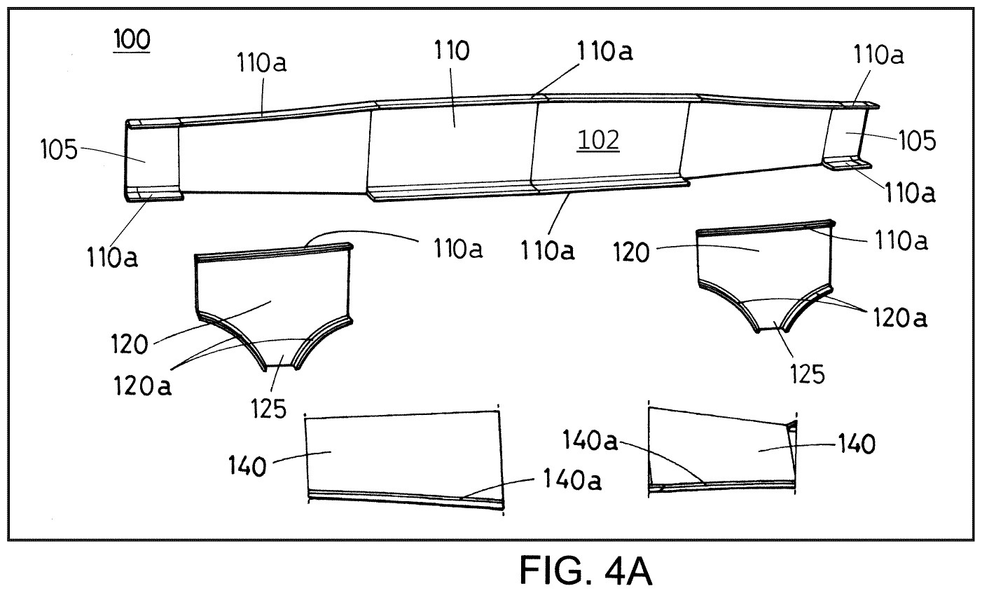

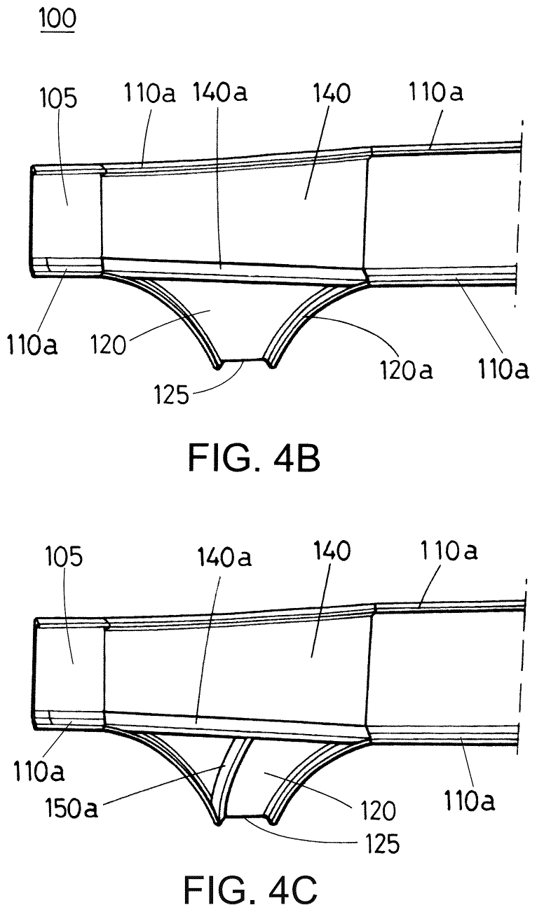

FIG. 4A shows a set of preforms forming a first example of a composite spar (100) according to the present invention.

FIG. 4A shows in the upper part of the figure a longitudinal spar element (102) preform comprising parts of the composite spar (100), such as the web (110) with two distal ends comprising the end portions (105) established in the longitudinal direction of the web (110), as well as upper and lower flanges (110a) of the composite spar (100).

FIG. 4A shows in the middle part of the figure two preforms comprising the curved-edged end portions (120) comprising curved flanges (120a), as well as some upper flanges (110a). As can be seen in FIG. 3, the curved-edged end portions (120) comprise the truncated section (125) that allows the connection of the composite spar (100) to the frame of the aircraft fuselage and allows the load transfer between the web (110) and the frame.

FIG. 4A shows in the lower part of the figure two preforms comprising two second reinforcement pieces (140) that can be assembled together with the rest of the preforms and that comprise, a part of the web (110) and second reinforcement flanges (140a) that comprise a rectilinear shape and that are configured to connect the lower flanges (110a) along the surface of the curved-edged end portion (120). For example, the webs of the curved-edge portions (120) are placed to abut and overlap a portion of the web (110) of the longitudinal spar element (102) and the webs of the second reinforcement pieces (140) are placed to abut and overlap portions of the webs of the curved-end portions (120) and the longitudinal spar element (102).

FIG. 4B shows a portion of the composite spar (100) comprising a set of assembled preforms. In particular, FIG. 4B shows the end portion (105) established in the longitudinal direction of the web (110) and the curved-edged end portion (120) of one of the distal ends of the composite spar (100). In addition, the curved flanges (120a) established in the curved-edged end portion (120) can be seen, as well as the truncated section (125) that allows the connection of the composite spar (100) to the frame of the fuselage of the aircraft. Some lower flanges (110a) and upper flanges (110a) of the composite spar (100) can also be seen.

FIG. 4B also shows the second reinforcement piece (140) comprising a part of the web (110) and second reinforcement flanges (140a) comprising a rectilinear shape and configured to connect the lower flanges (110a) along the surface of the curved-edged end portion (120) as seen in said figure. The second reinforcement pieces (140) allow to improve the transition of the different parts of the composite spar (100) and to reinforce the flanges of the composite spar (100), for example, the lower flanges (110a) and the curved flanges (120a). In addition, second reinforcement flanges (140a) allow transmitting loads between the lower flanges (110) adjacent to the curved-edged end portion (120).

FIG. 4C shows a portion of the composite spar (100) comprising a set of assembled preforms, analogously to FIG. 4B. Additionally, in FIG. 4C, the second reinforcing piece (140) comprises, in addition to the web (110) and the second reinforcing flanges (140a), third reinforcing flanges (150a) comprising a curved shape and configured to connect the curved flanges (120a) with the second reinforcing flanges (140a). The third reinforcing flanges (150a) allow the flanges of the composite spar (100) to be reinforced, for example, the curved flanges (120a) and to transmit loads between the curved flanges (120a) and the second reinforcing flanges (140a).

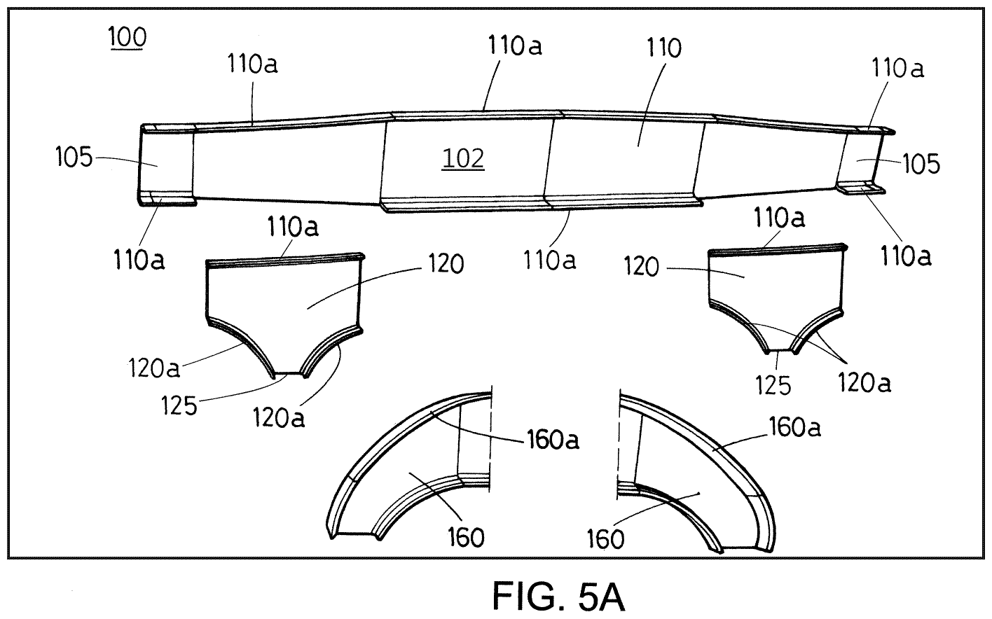

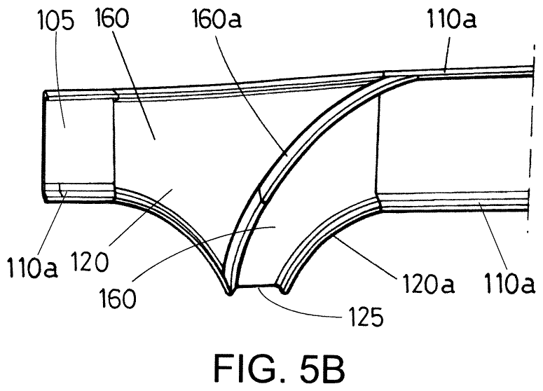

FIG. 5A shows, in the upper part of the figure, a preform comprising parts of the composite spar (100) including a longitudinal spar element (102) with two distal ends comprising the end portions (105) established in the longitudinal direction of the web (110), as well as upper and lower flanges (110a) of the composite spar (100).

FIG. 5A shows, in the middle part of the figure, two preforms comprising the end portions with curved edges (120) comprising curved flanges (120a), as well as some upper flanges (110a). As can be seen in FIG. 3, the curved-edged end portions (120) comprise the truncated section (125) that allows the connection of the composite spar (100) to the frame of the aircraft fuselage and allows the load transfer between the web (110) and the frame.

FIG. 5A shows in the lower part of the figure two preforms comprising two third reinforcement pieces (160) that can be assembled together with the rest of the preforms and that comprise, a part of the web (110) and third reinforcement flanges (160a) that comprise curved shapes to connect the curved flanges (120a) to the upper flanges (110a) and shapes equivalent to the lower flanges (110a) and to the curved flanges (120a).

FIG. 5B shows a portion of the composite spar (100) comprising a set of assembled preforms. In particular, FIG. 5B shows the end portion (105) established in the longitudinal direction of the web (110) and the curved-edged end portion (120) of one of the distal ends of the composite spar (100). In addition, the curved flanges (120a) established in the curved-edged end portion (120) can be seen, as well as the truncated section (125) that allows the connection of the composite spar (100) to the frame of the fuselage of the aircraft. The lower flanges (110a) and upper flanges (110a) of the composite spar (100) can also be seen.

FIG. 5B also shows the third reinforcement piece (160) comprising a web portion (110) and second reinforcement flanges (140a) and third reinforcement flanges (160a) comprising curved shapes for connecting the curved flanges (120a) to the upper flanges (110a) and equivalent shapes to the lower flanges (110a) and to the curved flanges (120a). The third reinforcement pieces (160) make it possible to improve the transition of the different portions of the composite spar (100) and to reinforce the flanges of the composite spar (100), for example, the curved flanges (120a) and the upper flanges (110a). In addition, the third reinforcement flanges (160a) allow loads to be transmitted between the curved flanges (120a) and the upper flanges (110a).

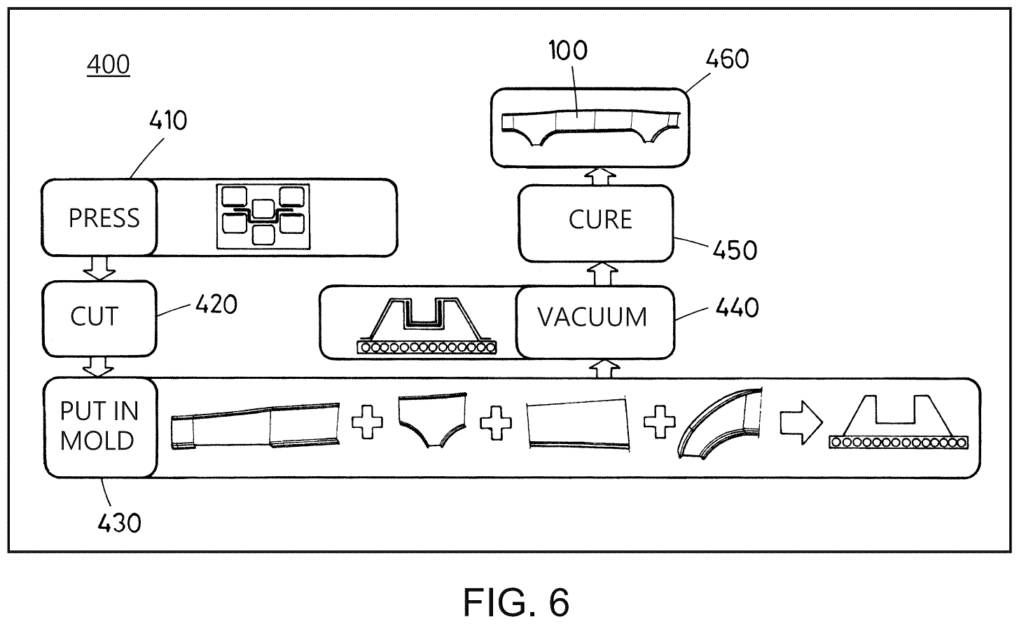

FIG. 6 shows an example of a method (400) for manufacturing the composite spar (100) according to the present invention.

The method (400) comprises a step of pressing (410) resin-impregnated composite sheets to obtain a set of fresh preforms. The resin-impregnated composite sheets comprise resin-impregnated fibers. The set of preforms may comprise a first preform comprising the web (110), distal end elements of the composite spar (100), such as the end portions (105) arranged in the longitudinal direction of the web (110), and upper and lower flanges (110a) of the composite spar (100).

The set of preforms may comprise two second preforms comprising end elements of the composite spar (100), such as the curved-edged end portions (120), as well as curved flanges (120a) and some upper flanges (110a).

The set of preforms may comprise one or more reinforcing pieces (130, 140, 160). The reinforcing pieces are assembled with the rest of the elements that make up the composite spar (100) and allow reinforcement of the final structure.

The method further comprises cutting (420) the set of preforms.

The method further comprises integrating (430) the set of preforms into an assembly mold.

The method (400) comprises vacuum-assembling (440) the parts to obtain a spar preform. In particular, this method can be carried out using a vacuum bag, as shown in FIG. 6.

The method (400) comprises curing (450) or co-curing the spar preform to obtain the final rigid preform and removing it from the vacuum assembly mold (e.g., a vacuum bag). The resin in the pre-impregnated composite sheets is cured during the curing of the spar preform.

The method (400) comprises the step of cutting (460) burrs from the cured preform to obtain the composite spar (100).

Additionally, the method (400) may comprise an additional inspection step, e.g., an ultrasonic inspection.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both, unless the disclosure states otherwise. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A composite spar configured to support a horizontal structure external to a fuselage of an aircraft, the composite spar comprising:
a longitudinal spar element with a web between upper and lower flanges;
two distal ends of the longitudinal spar element, wherein each of the two distal ends includes an end portion established in a longitudinal direction of the web, a curved-edged end portion with curved flanges and a truncated section established in the transverse direction of the web,
wherein the truncated section is configured to connect to a frame of the fuselage and configured as a load transfer element between the web and the frame, and
wherein one or more of the lower flanges are connected to the curved flanges.

2. The composite spar according to claim 1, wherein each of the end portions established in the longitudinal direction of the web comprises a second truncated section configured to connect the composite spar to the horizontal structure of the aircraft.

3. The composite spar according to claim 1, wherein the upper and lower flanges are rectilinear.

4. The composite spar according to claim 1, further comprising first reinforcement pieces each comprising a web overlapping a portion of the web of the longitudinal spar element and a web of a respective one of the curved-edged portions, wherein each of the first reinforcement pieces further includes a reinforcement flange extending from the lower flange of the longitudinal spar element and one of the curved flanges of the respective one of the curved-edged portions.

5. The composite spar according to claim 1, further comprising a second reinforcement piece comprising a web overlapping a portion of a web of one of the curved-edge end portion and a portion of the web of the longitudinal spar element, wherein the second reinforcement flanges are rectilinear in shape and connect the lower flanges of the longitudinal spar element to one of the curved flanges of the curved-edged end portion.

6. The composite spar according to claim 1, wherein the second reinforcement piece further comprises third reinforcement flanges comprising curved shapes and each connecting the one of the curved flanges with one of the second reinforcement flanges.

7. The composite spar according to claim 1, further comprising a third reinforcement piece that includes third reinforcement flanges including:
flanges with curved shapes and connecting the curved flanges to the upper flanges; and
flanges with curved shapes connecting the lower flange and with one of the curved flanges.

8. A central box of the wing of an aircraft comprising a plurality of composite spars, wherein each of the composite spars is the composite spar according to claim 1.

9. A horizontal stabilizer for an aircraft, the horizontal stabilizer comprising a plurality of composite spars each being the composite spar according to claim 1.

10. A horizontal support pylon for an aircraft engine, the horizontal support pylon including a plurality of composite spars each of which is the composite spare according to claim 1.

11. A method of manufacturing a composite spar comprising:
pressing resin pre-impregnated composite sheets to obtain a set of preforms, wherein each of the preforms includes:
a first preform configured to form a longitudinal spar element and including a web, end portions and an upper flange and a lower flange;
second preforms configured as a curved-edged end portions each with a web positioned in an overlapping relationship with a portion of the web of the first preform and each with an upper flange configured to abut and overlap the upper flange of the first preform and a curved flange with a first end abutting an end of the lower flange of the first preform and a second end at a truncated edge of the second preform, and
third preforms each including a web overlapping portions of both the web of one of the second preforms and the web of the first preform,
integrating the first, second and third preforms in a vacuum assembly mold such that the webs of the second preforms overlap with portions of the web of the first preform and the web of each the third preforms overlap with portions of the web of one of the second preforms and the web of the first preform, and the upper flange of each of the second preforms overlap with portions of the upper flange of the first preform and the first end of the curved flange in each of the second preforms is adjacent one of the ends of the lower flange of the first perform;
after the vacuum assembling, curing the first, second and third preforms to form the composite spar and removing the cured composite spar from the vacuum assembly mold; and
removing burrs from the composite spar.

12. The method according to claim 11, wherein the third preforms comprise a first reinforcement piece including a web and first reinforcement flanges at an edge of the web, wherein the first reinforcement flanges extend from the lower flange of the first preform to one of the curved flanges of a respective one of the second preforms.

13. The method according to claim 11, wherein the third preforms comprise a second reinforcement piece including a web and second reinforcement flanges each having a rectilinear shape and connect the lower flange of the first preform and to one of the curved flanges of a respective one of the second preforms.

14. The method of claim 13, wherein the second reinforcement piece comprises a third reinforcement flange including a curved shape and connecting one of the curved flanges of the second preforms with one of the second reinforcement flanges.

15. The method according to claim 11, wherein the third preforms each comprise a third reinforcement piece including third reinforcement flanges,
wherein the third reinforcement flanges includes:
a first curved shape connecting one of the curved flanges of a respective one of the second preform to the upper flange of the first preform, and
a second curved shape configured to connect the lower flange of the first preform to one of the curved flanges of a respective one of the second preform.

16. An assembly of preforms arranged to form a composite spar configured to support a horizontal structure external to a fuselage of an aircraft, the composite spar comprising:
a longitudinal spar element preform including a web, a continuous upper flange and a discontinuous lower flange with a gap in the lower flange at each of distal end portions of the longitudinal spar element preform; and
curved edge preforms each aligned with one of the gaps in the lower flange of the longitudinal spar element,
wherein each of the curved edge preforms includes a web overlapping a portion of the web of the longitudinal spar element, an upper flange at an upper edge of the web of the curved edge preform and curved flanges at lower edges of the web of the curved edge preform,
wherein the upper flange of each of the curved edge preforms abuts and overlaps a portion of the upper flange of the longitudinal spar element preform, and
wherein the curved flanges of each of the curved edge preforms extend from the lower flange of the longitudinal spar to a truncated end of the curved edge preform.

17. The assembly of claim 16, further comprising first reinforcement preforms each including a web and a first reinforcement flange, wherein the web of each of the first reinforcement preforms overlaps a portion of the web of the longitudinal spar element preform and a portion of the web of one of the curved edge preforms, and the first reinforcement flange extends from the upper flange of the longitudinal spar element preform to a first one of the curved flanges of the respective one of the curved edge preforms.

18. The assembly of claim 17, wherein the first reinforcement preforms includes a second reinforcement flange extending from the lower flange of the longitudinal spar element preform to a second one of the curved flanges of the respective one of the curved edge preforms.

19. The assembly of claim 16, further comprising second reinforcement preforms each including a web overlapping a portion of the web of the longitudinal spar element preform and a portion of the web of the curved edge preform and a second reinforcement flange aligned with the lower flange of the longitudinal spar element preform and spanning one of the gaps in the lower flange of the longitudinal spar element preform.

20. The assembly according to claim 19, wherein the second reinforcement pieces each include a third reinforcement flange having a curved shape and extending from the second reinforcement flange to one of the curved flanges of the respective one of the curved edge preforms.
